(19) United States
(12) Patent Application Publication
(10) Pub. No.: US 2002/0180278 A1
(43) Pub. Date: Dec. 5, 2002

(54) Circuit arrangement and device for safely disconnecting an element in an installation, in particular a machine installation

(76) Inventors: Richard Veil, Stuttgart (DE); Roland Rupp, Hattenhofen (DE); Holger Bode, Edingen-Neckarhausen (DE)

Correspondence Address: HARNESS, DICKEY & PIERCE, P.L.C., P.O. BOX 828, BLOOMFIELD HILLS, MI, 48303, US

(21) Appl. No.: 10/175,373

(22) Filed: Jun. 19, 2002

Related U.S. Application Data
(63) Continuation of application No. PCT/EP00/12632, filed on Dec. 13, 2000.

(30) Foreign Application Priority Data
Dec. 23, 1999 (DE) 199 62 497.6

(51) Int. Cl. H02H 1/00

(52) U.S. Cl. 307/326

(57) ABSTRACT

The present invention relates to a circuit arrangement for safe disconnection of an installation, in particular a machine installation. The arrangement comprises a signaling device which produces a defined output signal depending on an operating condition of the installation. Furthermore, it comprises a safety switching device which disconnects the installation in a fail-safe manner depending on the defined output signal. The defined output signal comprises a steady-state signal level over a period of time during operation of the installation. According to one aspect of the invention, the safety switching device comprises a clock generator for generating a clock signal, and an input stage which modulates the output signal from the signaling device with the clock signal.

### CROSS-REFERENCES TO RELATED APPLICATIONS

This application is a continuation of copending international patent application PCT/EP00/12632 filed on Dec. 13, 2000 and designating the U.S., which claims priority of German patent application DE 199 62 497.6 filed on Dec. 23, 1999.

### BACKGROUND OF THE INVENTION

The present invention relates to a circuit arrangement for safe disconnection of at least an element in an installation, in particular a machine installation. The invention particularly relates to a circuit arrangement comprising a signaling device which produces a defined output signal depending on an operating condition of the installation, and a safety switching device which disconnects the element in a fail-safe manner depending on the defined output signal, wherein the defined output signal comprises a steady-state signal level over a period of time T₁during operation of the installation.

The invention furthermore relates to a safety switching device for use in such a circuit arrangement, having at least one input for connecting a signaling device and having a disconnection unit, which initiates a fail-safe disconnection process depending on a defined output signal which is produced by the signaling device.

Such a circuit arrangement and such a safety switching device are known, for example, from the book “Maschinensicherheit” [Machine Safety] by Winfried Gräf, which was published in 1997 by the Hüthig-Verlag Germany, pages 204, 205.

In the known circuit arrangement, the signaling device is a safety light barrier by means of which, for example, it is possible to protect the danger area of a press installation or of an automated machining center. For this purpose, the safety light barrier produces an output signal which changes from a first signal state to a second signal state when one or more light beams of the light barrier are broken. This change is identified by the connected safety switching device, and the safety switching device then initiates a disconnection process in the monitored installation, in a fail-safe manner. The disconnection process may include that the monitored installation is disconnected from electrical power as a whole. However, in many practical applications, it is sufficient just to disconnect only a part of the installation, for example a drive.

Fail-safe disconnection requires that the circuit arrangement be designed overall such that, even in the event of a fault within the circuit arrangement, any hazard from the installation is precluded. This is achieved primarily by both the signaling device and the safety switching device including fail-safe measures, such as multichannel, redundant signal paths and/or self-tests that are carried out repeatedly.

The present invention is not just restricted to light barriers as signaling devices. Other examples of signaling devices are door contact switches, emergency-off buttons and, in general, all types of sensors by means of which it is possible to detect that an installation being monitored is in a safety-critical operating condition.

In principle, nowadays, a distinction can be drawn between two types of such signaling devices. In the one type, the signaling devices have an output with contacts. This is essentially a switch, whose opening and closing positions are influenced by the signaling device. An output with contacts can be evaluated by the downstream safety switching device by feeding back a test signal, which is produced by itself, via the contact switch in the form of a loop. By comparing the test signal produced by itself with the fed-back input signal, it is possible to determine whether the output of the signaling device with contacts is open or closed. In general, it can be said that, in this case, the output of the signaling device is connected via a loop connection to the safety switching device, with the signaling device itself not producing any active output signal.

In contrast, the second group of signaling devices has active signal outputs, namely in the form of semiconductor outputs in general. This means that the signaling device produces a current and/or voltage signal, which indicates the operating condition of the installation being monitored, independently of the safety switching device. The known circuit arrangement from the book by Gräf is, for example, a light barrier with such a semiconductor output.

Many signaling devices are subject to the problem that they are activated only comparatively rarely during normal operation of the installation to be monitored, so that the output of the signaling device remains statically in one signal state over very long periods of time. From the point of view of the switching device, it is impossible in a case like this to identify whether this steady signal state corresponds to the actual operating condition of the installation, or whether it is caused by a fault, for example by a short circuit having occurred in the meantime between isolated lines. In the case of signaling devices having outputs with contacts, it is thus known for the safety switching device to change the test signal that is carried in the signal loop, at periodic time intervals. These deliberate signal changes allow the safety switching device to check both the connection via the output contact of the signaling device and its own signal processing paths for absence of faults. An arrangement like this is known, for example, from DE 195 10 332 A1.

However, this method cannot be used for signaling devices with active signal outputs that have no contacts since, in this case, the output signal is not controlled by the safety switching device itself. For this reason, some of the signaling devices used in practice and having an active signal output have an additional test input, via which the safety switching device can demand a deliberate state change in the output signal for test purposes. One example of this is the FGS safety light barrier from the company Sick AG from 40549 Dusseldorf, Germany. However, the safety switching device is always required to cooperate with the signaling device in these cases in order to carry out a functional check, which restricts the interoperability with different signaling devices.

Furthermore, by virtue of their use, signaling devices with active signal outputs are known which carry out their own fault checking measures internally. In this case, the signaling device itself produces short signal changes at its output, at defined time intervals. However, since these signal changes are likewise not under the control of the downstream safety switching device, they are not suitable for carrying out a self-test of the safety switching device independently of the signaling device being used.

### SUMMARY OF THE INVENTION

It is an object of the present invention to specify an alternative circuit arrangement, in which the safety switching device is capable of carrying out a self-test of its signal paths independently of the signaling device being used. A further object of the invention is to specify a corresponding safety switching device.

In the case of a circuit arrangement of the type initially mentioned, this object is achieved by the safety switching device comprising a clock generator for generating a preferably periodic clock signal, and comprising an input stage which modulates the output signal from the signaling device with the clock signal.

The object is furthermore achieved by a safety switching device of the type initially mentioned, which comprises a clock generator for generating a preferably periodic clock signal, and comprises an input stage which modulates the output signal of the signaling device with the clock signal.

The modulation process results in the clock signal, which is under the control of the safety switching device, being combined with the output signal from the signaling device. By modulation, this is done in such a way that the information contents of the defined output signal and of the periodic clock signal are both contained in the modulated output signal. In this case, owing to the clock signal, the modulated output signal has preferably periodic signal changes which make it possible for the safety switching device to carry out an autonomous, internal functional check of its signal paths, during operation of the installation. This can be done independently of the output signal and, in consequence, also independently of any cooperation with the preceding signaling device. Nevertheless, the safety switching device is always capable to identify any signal changes in the defined output signal, since the clock signal is known to it.

The arrangement according to the invention thus has the advantage that the safety switching device can carry out an internal functional check independently of the preceding signaling device, to be precise even when the preceding signaling device has an active signal output. There is no longer any need to include the signaling device in the self-test, for example by demanding a test signal from the signaling device. The safety switching device according to the invention can thus be combined with any desired signaling devices to form the circuit arrangement according to the invention.

Moreover, the circuit arrangement according to the invention and the corresponding safety switching device have a number of further advantages, which will be explained in the following text, particularly with reference to preferred refinements.

In a first refinement of the circuit arrangement according to the invention, the safety switching device disconnects the installation as a function of the modulated output signal.

As an alternative to this measure it would, in principle, also be feasible to use the modulated output signal only in a supplementary manner for self-testing of the safety switching device, with only the defined, unmodulated output signal still being used for the actual monitoring of the operating condition of the installation. In contrast, the said measure has the advantage that the modulated output signal passes exactly through that signal path that is important during the internal functional check of the safety switching device. This simplifies the complexity on the one hand and, on the other, allows functional checking substantially to be carried out without any gaps and continuously.

In a further refinement, the defined output signal is a digital signal and the input stage comprises a logic unit which modulates the defined output signal by means of a logic interconnection with the clock signal.

This measure can be implemented very easily and cost-effectively in comparison to analog signal processing, for example by means of a mixer. Furthermore, it can be expected that future signaling devices will generally provide digital output signals, which can be evaluated very easily on the basis of this measure, despite the modulation.

In a further refinement of the measure mentioned above, the logic interconnection is an exclusive-NOR or an exclusive-OR interconnection.

Compared to other logic interconnection, for example an AND interconnection, these two interconnections have the advantage that the clock signal is substantially retained in the modulated output signal. In this case, the clock signal is just inverted or not inverted, depending on the signal level of the defined output signal. In consequence, the modulated output signal has the same signal changes as the clock signal. This makes continuous functional checking very simple, even when the installation is in the passive state.

In a further refinement of the invention, the input stage comprises signal processor which separates the clock signal and the modulated output signal from one another in a fail-safe manner.

Such separation of the two signals can be implemented technically in various ways, as will be explained in the following text with reference to further refinements of the invention. Overall, the measure has the advantage that it eliminates a confusion of the clock signal on the one hand and of the modulated output signal on the other hand. In consequence, this measure considerably increases the safety of the circuit arrangement since it avoids any unknown, faulty cross-connection between the clock signal and the modulated output signal.

In one refinement of the measure mentioned above, the signal processor galvanically isolates [DC-isolates] the clock signal and the modulated output signal from one another.

Galvanic isolation precludes any short circuit or cross-connection between the two signals in a simple and fail-safe manner, once the installation has been brought into use without any faults. It is thus sufficient to check the fault-free operation of the circuit once, before or at the start of initial use. In this case, it is impossible for any subsequent cross-connection to occur during operation, for example as a result of a component defect such as the breakdown of a transistor.

In a further refinement, the signal processor galvanically isolates the clock signal and the modulated output signal from one another by means of an optocoupler.

In comparison to other possible ways to achieve galvanic isolation, an optocoupler is very cost-effective and space-saving and, furthermore, has the advantage that it is not susceptible to electromagnetic interference. Furthermore, it does not itself produce any electromagnetic interference, or only comparatively little electromagnetic interference.

In a further refinement, the signal processor changes at least one signal parameter of the modulated output signal differently from the clock signal.

Signal parameters for the purposes of this refinement of the invention may be, for example, the amplitude, the phase angle or else the number of pulses per unit of time in the respective signal. As a result of the signal processor changing one such signal parameter of one of the two said signals differently from the other, they produce a distinguishing feature on the basis of which an evaluation unit can reliably identify which of the two signals is actually present. In this case, this measure may be used in addition to or as an alternative to the above-mentioned measures. Overall, this increases the design options for the development of a circuit arrangement according to the invention. If required, this also makes it possible to avoid the use of components with galvanic isolation.

In a further refinement of the invention, the safety switching device comprises a housing with externally accessible connecting terminals, and the clock signal is supplied from the outside to the input stage via one of the connecting terminals.

As an alternative to this measure, it is also in principle feasible to supply the clock signal to the input stage within the housing of the safety switching device. In this preferred refinement, however, the clock signal is supplied to the input stage via a loop connection which is routed out of the housing. This measure has the advantage that it also allows to connect signaling devices with signal outputs having contacts to the inventive safety switching device very easily and without any change to the safety switching device itself being required for this purpose. In this case, it is sufficient to pass the clock signal via the contact of such a signaling device, if, at the same time, a constant signal level is applied to the input for connection of a signaling device with an active signal output. Overall, this measure considerably increases the field of use of the safety switching device according to the invention.

In a further refinement of the invention, the safety switching device comprises at least two housing modules which can be separated from one another, with the input stage being arranged on its own in one of the separable housing modules.

This measure has the advantage that the input stage of the safety switching device can be used in a modular manner as required, thus likewise increasing the field of use of the safety switching device according to the invention. Furthermore, this means that it is simple to retrofit relatively old safety switching devices in the manner according to the invention.

In a further refinement of the invention, the input stage comprises a filter circuit by means of which pulses can be suppressed whose time duration is shorter than a shortest pulse duration of the clock signal.

This measure has the advantage that the inventive safety switching device is protected against interference which is present at the signal inputs in the form of brief pulses which cannot be evaluated deterministically. Pulses such as these are, for example, test pulses which a number of relatively modern signaling devices, for example a number of light barriers, produce, in order to carry out their own functional tests. The safety switching device according to the invention is less susceptible to such interference by virtue of the said measure, and can thus be combined with any desired signaling devices irrespective of whether such test pulses are present.

In a further refinement, the clock signal is controlled by an evaluation unit of the safety switching device.

This measure has the advantage that the evaluation unit has complete control over the clock signal. This substantially precludes any difference between that clock signal which is used for modulation of the defined output signal and that clock signal which is known to the evaluation unit.

In a further refinement of the invention, at least the input stage of the safety switching device is designed in a multi-channel fashion.

This measure results in even better reliability, since it allows an additional functional check to be carried out by a comparison, or a mutual check, between the at least two channels.

It goes without saying that the features mentioned above and the features which are still to be explained in the following text can be used not only in the respectively stated combination but also in other combinations or on their own, without departing from the scope of the present invention.

### BRIEF DESCRIPTION OF THE DRAWINGS

Exemplary embodiments of the invention are explained in more detail in the following description and are illustrated in the drawing. It shows:

FIG. 1 a first exemplary embodiment of a circuit arrangement according to the invention, with the input stage of the safety switching device being arranged in a separate housing module,

FIG. 2 the design of the input stage shown in FIG. 1,

FIG. 3 a second exemplary embodiment of the invention, and

FIG. 4 the time relationships between the defined output signal, the clock signal and the modulated output signal.

### DETAILED DESCRIPTION OF PREFERRED EMBODIMENTS

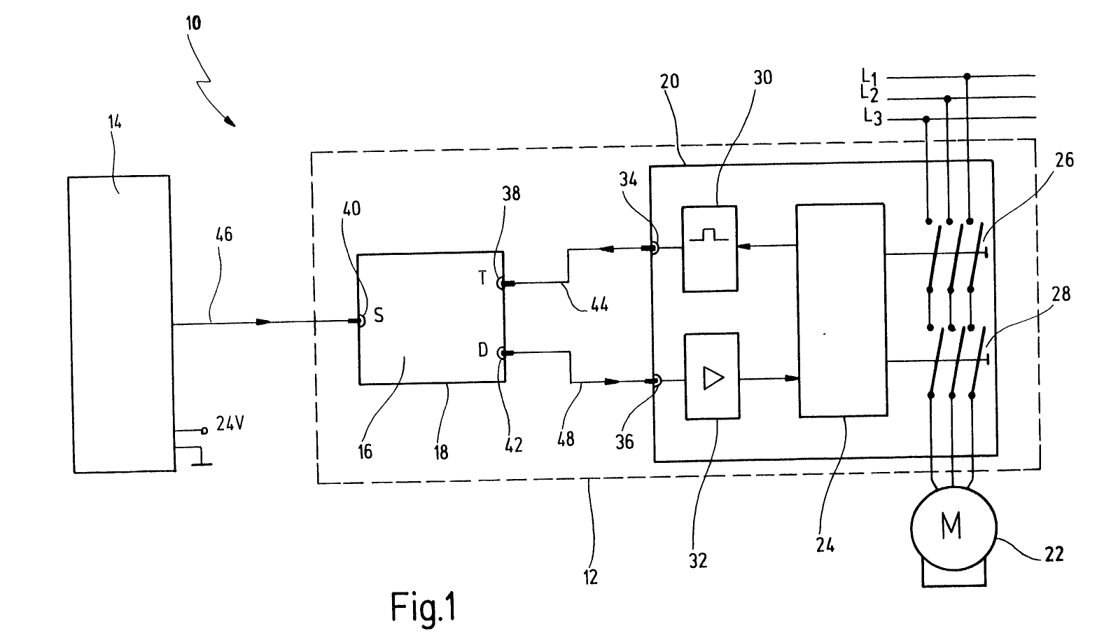

In FIG. 1, a circuit arrangement according to the invention is designated as a whole by the reference number 10.

In the present case, the circuit arrangement 10 comprises a safety switching device 12 and a signaling device 14. By way of example, the signaling device 14 is in this case assumed to be a light barrier but, in general, it may be any suitable sensor which produces a characteristic output signal for the operating condition of an installation to be monitored.

The safety switching device 12 has an input stage 16 which is arranged on its own in a housing module 18. The other components of the safety switching device 12 are arranged in a second housing module 20, which can be separated from the housing module 18.

Reference number 22 designates a machine installation whose operating condition is monitored by the circuit arrangement 10. This includes not only machine parameters in the relatively narrow sense, such as a machine rotational speed, but also state variables associated with the machine installation 22 in a wider sense, for example the position of an emergency-off button, the opening or closing of a guard door or the state signal from the light barrier 14 which is used to protect a danger area relating to the machine installation 22.

Furthermore, the invention is not just restricted to machine installations, such as a hydraulic press or a machining center. In an entirely general form, the installation to be monitored may also be a chemical production plant or any process which must be changed to a safe state when a fault occurs. In the case of the machine installation 22 assumed here, the safe state is reached, by way of example, by disconnecting the power supply.

That part of the safety switching device 12 which is arranged in the housing module 20 has, in a manner known per se, an evaluation and disconnection unit 24, which preferably has two channels and a redundant design. In a manner which is likewise known, the evaluation and disconnection unit 24 has output relays or output contactors, whose make contacts 26, 28 are connected in series in the power supply to the machine installation 22.

The reference number 30 denotes a clock generator, whose clock signal is controlled by the evaluation and disconnection unit 24.

The reference number 32 denotes an amplifier which, in this case, symbolically represents all the measures that are required, such as level matching, pulse shaping and/or impedance matching. Additionally, it is thereby achieved here that the evaluation and disconnection unit 24 does not affect the input stage 16.

In a manner known per se, the housing module 20 has a number of connecting terminals, two of which are in this case designated by the reference numbers 34 and 36. The housing module 18 with the input stage 16 likewise has connecting terminals, which are designated by the reference numbers 38, 40 and 42. The input stage 16 is connected via the connecting terminals 34, 38 to the clock generator 30 within the housing module 20. Via these terminals 34, 38, it receives the clock signal 44 which, in this case, is preferably a periodic clock signal. However, in principle, the clock signal 44 may also be an asynchronous signal.

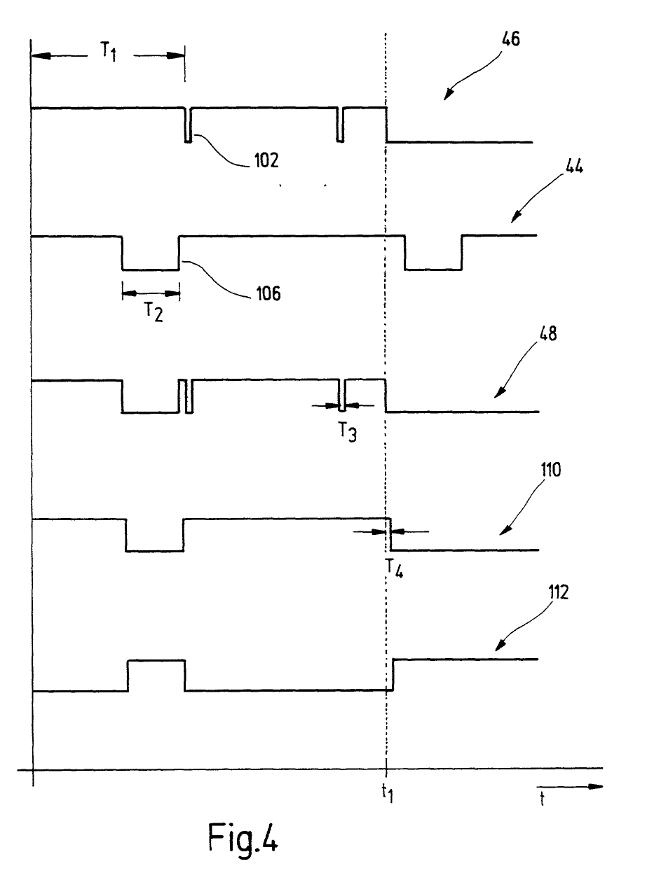

The input stage 16 is connected via the connecting terminal 40 to the signaling device 14 and, via this connecting terminal 40, it receives a defined output signal 46 whose respective signal state depends on an operating condition of the machine installation 22. In the present exemplary embodiment, the output signal 46 is a digital signal which is at a high level when the light barrier is not broken, and is at a low level when the light barrier is broken. Furthermore, the output signal 46 has brief disconnection pulses, as will be explained in more detail with reference to FIG. 4.

The input stage 16 is furthermore connected via the connecting terminals 36 and 42 to the amplifier 32. The input stage 16 uses this connection to transmit a modulated output signal 48, which is obtained from the interconnection of the periodic clock signal 44 and the defined output signal 46, as explained in the following. The modulated output signal 48 is then evaluated by the evaluation and disconnection unit 24 and, depending on this evaluation, the evaluation and disconnection unit 24 may disconnect the power supply to the machine installation 22.

Furthermore, the evaluation and disconnection unit 24 uses the modulated output signal 48 to carry out its own functional test on the safety switching device 12. If a fault or an undefined condition is identified in this process, the machine installation 22 is likewise disconnected. For this purpose, the evaluation and disconnection unit 24 has safety devices (not illustrated here) in a manner known per se.

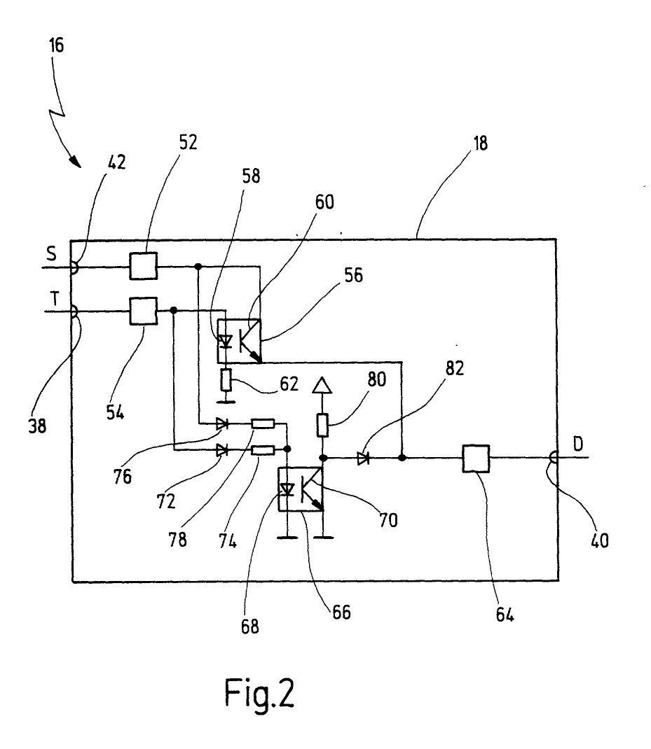

FIG. 2 shows the internal circuit design of the input stage 16. In this case, the same reference numbers are used to denote the same elements as in FIG. 1. In addition, the clock signal 44 is abbreviated by the letter T, the defined output signal 46 is abbreviated by the letter S, and the modulated output signal 48 is abbreviated by the letter D, as is normal when explaining logic interconnections.

The clock signal T and the defined output signal S are first of all received in the input stage 16 by two circuits 52, 54, which are used for level matching, pulse shaping, filtering etc. The circuits 52, 54 are optional and are to be matched in a manner known per se to the respective requirements. After this, the clock signal T and the defined output signal S are supplied to an optocoupler 56, with the clock signal T driving an input-side light-emitting diode 58, while the defined output signal S is passed to the collector of a photosensitive transistor 60. The cathode-side connection of the light-emitting diode 58 is connected to ground via a resistor 62. The emitter connection of the transistor 60 is connected to a circuit 64, which is used for level matching, pulse shaping, etc. in the same way as the circuits 52, 54. The modulated output signal D is produced at the output of the circuit 64.

The reference number 66 denotes a second optocoupler with an input-side light-emitting diode 68 and a photosensitive transistor 70. The cathode-side connection of the light-emitting diode 68 is connected to ground. The anode-side connection of the light-emitting diode 68 is connected to two series circuits, which are arranged in parallel with one another and each have a diode and a resistor. The clock signal T is supplied to the light-emitting diode 68 via one of the two series circuits, comprising the diode 72 and the resistor 74. The defined output signal S is supplied to the light-emitting diode 68 via the second of the two series circuits, comprising the diode 76 and the resistor 78.

The emitter-side connection of the transistor 70 of the optocoupler 66 is once again connected to ground. On the collector side, the transistor 70 is connected via a resistor 80 to the supply voltage. Furthermore, the collector of the transistor 70 is connected via a forward-biased diode 82 to the emitter of the transistor 60 of the optocoupler 56.

Overall, in this case, the input stage 16 provides a failsafe exclusive-NOR interconnection, that is to say the signals S, T and D are logically interconnected to one another in accordance with the following truth table:

| S | T | D |
|---|---|---|
| 0 | 0 | 1 |
| 0 | 1 | 0 |
| 1 | 0 | 0 |
| 1 | 1 | 1 |

The input stage 16 operates as follows:

When the clock signal T is at a high level, the transistor 60 of the optocoupler 56 is switched on via the light-emitting diode 58. The transistor 70 of the optocoupler 66 is likewise switched on via the light-emitting diode 68. In consequence, the defined output signal S is passed on via the transistor 60 of the optocoupler 56 to the output terminal 40 of the input stage 16, with the pull-up resistor 18 ensuring that the signal level is stable. When the clock signal T is at a high level, the signal level of the modulated output signal D is thus identical to the signal level of the defined output signal S.

When, in contrast, the clock signal T is at a low level, the transistor 60 of the optocoupler 56 is switched off, so that the defined output signal S is not passed through directly to the output terminal 40. Furthermore, the transistor 70 of the optocoupler 66 is also switched off, provided it is not switched on by the defined output signal S being at a high level. If it is switched on by the defined output signal S being at a high level, it draws the signal level of the modulated output signal D to ground, so that this is at a low level. If, in contrast, the defined output signal S is in a low state, the transistor 70 of the optocoupler 66 is also switched off, so that the signal level of the modulated output signal D is drawn to a high level via the pull-up resistor 18. Overall, in this case, the modulated output signal D thus corresponds to the inverted output signal S.

In general, it can be said that the modulated output signal D is identical to the clock signal T when the defined output signal S is at a high level, while it is inverted with respect to the periodic clock signal T when the defined output signal S is at a low level. This corresponds precisely to the exclusive-NOR interconnection as is described in the above table.

The modulated output signal D thus has signal levels which alternate periodically and by means of which the evaluation and disconnection unit 24 of the safety switching device 12 can carry out an internal functional test. At the same time, however, the modulated output signal D always allows to deduce also the current signal level of the defined output signal S. The safety switching device 12 can thus react at any time to the light barrier 14 being broken.

Furthermore, the present exclusive-NOR interconnection of the input stage 16 is also failsafe with regard to any conceivable short circuits or signal interruptions. If, for example, the defined output signal S is at a high level, both a short circuit. and an interruption of the light-emitting diode 58 result in the transistor 60 being switched off, which results in the modulated output signal D being at a permanent low level. Any interruption in the transistor 60 has the same effect. A short-circuit in the transistor 60, for example as a result of a breakdown, leads to the modulated output signal D being at a continuous high level. In contrast to the situation during normal operation, the modulated output signal D no longer has any clock pulses in any situation, and the downstream evaluation and disconnection unit 24 can identify this as a fault or disconnection command.

When the clock signal T is at a low level, any interruption in the diode 76 or in the resistor 78 leads to the transistor 70 of the optocoupler 66 being switched off. In consequence, the modulated output signal D is once again at a permanent high level, and this can be identified as a fault or disconnection command.

A short-circuit of the diode 76 in conjunction with an interruption in the light-emitting diode 68 can also be identified since, in this case, the transistor 70 of the optocoupler 66 is once again switched off, and this leads to the modulated output signal D being at a permanent high level. Any further possible direct coupling between the periodic clock signal T and the output terminal 40 via the signal path comprising the diode 72, the resistor 74, the resistor 78 and the transistor 60 can also be identified in this way. Furthermore, the use of the optocoupler 56 makes it possible to preclude the clock signal T being coupled directly to the output terminal 40.

A comparable fault analysis can be carried out for when the defined output signal S is at a low level, that is to say in this case as well all the short circuits or interruptions that occur can be identified, since they lead to the modulated output signal D having an unchanging response. The input stage 16 is thus designed in a failsafe manner.

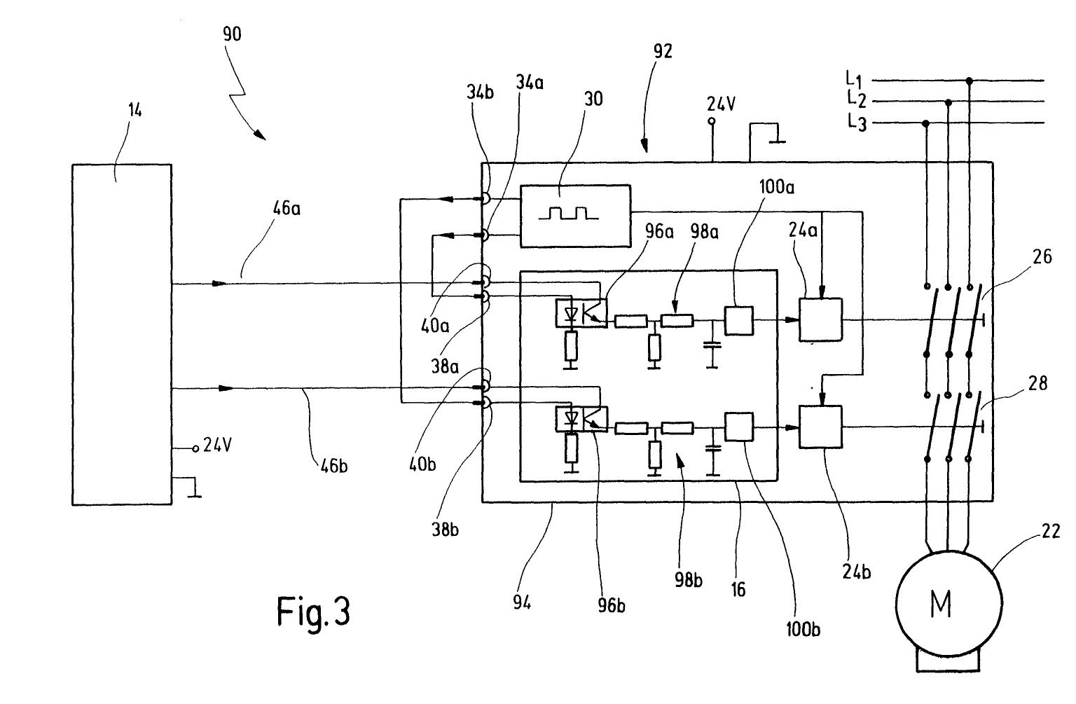

In FIG. 3, a second exemplary embodiment of a circuit arrangement according to the invention is designated by the reference number 90 as a whole. Identical reference numbers in this case once again denote the same elements as in FIG. 1. The circuit arrangement 90, including the signaling device 40, is always designed to have two channels. The letters “a” and “b” are added to the respectively identical reference symbols in order to distinguish between the two channels.

In the case of the circuit arrangement 90, the safety switching device 92 is arranged completely in a housing 94. The input stage 16 of the safety switching device 92 is in this case thus integrated permanently in the safety switching device 92.

The periodic clock signal T from the clock generator 30 and the defined output signal S from the signaling device 14 are once again interconnected to one another in the input stage 16 via an optocoupler 96. In this case, the periodic clock signal T once again controls an input-side light-emitting diode, while the defined output signal S is passed via the collector-emitter path through a photosensitive transistor. In contrast to the previous exemplary embodiment, however, there is no further circuitry in this case to influence the logic interconnection, so that this results in a logic AND interconnection in this case. However, it goes without saying that the input stage 16 of this exemplary embodiment may, alternatively, also include an exclusive-NOR or an exclusive-OR interconnection.

In each of the two channels, the optocoupler 96 is followed by a filter circuit 98, which is designed such that pulses whose time duration is shorter than the shortest pulse duration of the periodic clock signal T are suppressed. The effect of the filter circuit 98 can clearly be seen from the timing diagrams in FIG. 4.

The reference numbers 100a, 100b denote two inverters having a Schmitt-trigger input, and these are used to invert the filtered modulated output signal. In consequence, the modulated output signal D can always be distinguished from the periodic clock signal T, so that a faulty cross-connection between the two signals can be identified in the evaluation and disconnection unit 24.

One special feature of the safety switching device 92 is that the periodic clock signal T from the clock generator 30 is first of all passed out of the housing 94 via the output terminals 34a, 34b, and is then supplied to the input stage 16 via a loop connection and the input terminals 38a, 38b. In principle, and in contrast to this, it is also possible to supply the clock signal T to the input stage 16 within the housing 94. However and in contrast, with the present embodiment, it is easily possible to connect a signaling device with contacts to the safety switching device 92, as well. To do this, the periodic clock signal T is passed to the input terminals 40a, 40b via the output contact of such a signaling device. A steady-state high level has then to be applied to the input terminals 38a, 38b of the input stage 16 at the same time.

The method of operation of the circuit arrangement 90 can be seen from the illustration of the time profiles in FIG. 4. In this case, the upper signal profile shows the defined output signal 46 from the signaling device 14. As can be seen, this has superimposed on it, in the present case, short test pulses 102, whose time period T₃ is very short in comparison to the time period T₁ during which the defined output signal 46 is at a steady-state signal level. It is assumed that the light barrier 14 is broken at the time t₁, which means that the defined output signal 46 changes from a high level to a low level at this time.

The second signal profile shows the periodic clock signal 44, which has pulses with a pulse duration of T₂ at constant time intervals. The pulse duration T₂ is considerably longer than the pulse duration T₃ of the test pulses 102. However, it is considerably shorter than the time period T₁ of the defined output signal 46.

The third time profile shown is the modulated output signal 48, which is obtained from the logic AND interconnection of the two signals 46 and 44. It can be seen that, once the light barrier 14 has been broken at the time t₁, the modulated output signal 48 is at a steady-state low level, which the evaluation and disconnection unit 24 can identify as a disconnection command.

The fourth signal profile 110 shows the modulated output signal 48 at the output of the filter circuit 98, in which the short pulses 102 are suppressed. Furthermore, this takes account of the filter delay time T₄ of the input stage 16 of the safety switching device 92.

The fifth time profile 112 shows the signal at the output of the inverters 100. As can be seen here, this signal always differs from the periodic clock signal 44, so that the evaluation and disconnection unit 24 can always separate the modulated output signal at the output of the inverters 100 from the periodic clock signal 44. This allows the evaluation and disconnection unit 24 to identify a faulty cross-connection.

What is claimed is:

1. In a machine installation, a circuit arrangement for safely disconnecting at least one element of said machine installation from electrical power, said machine installation comprising an operating condition which can change during operation, said arrangement comprising:
a signaling device which produces a defined output signal depending on said operating condition, said defined output signal reflecting a change of said operating condition and comprising a steady-state signal level over a period of time during operation of said machine installation, and
a safety switching device connected to said signaling device, said safety switching device disconnecting said element from said electrical power in a fail-safe manner as a function of said defined output signal,
wherein said safety switching device comprises a clock generator for generating a clock signal, and an input stage receiving said defined output signal and said clock signal, and
wherein said input stage modulates at least said steady-state signal level of said defined output signal with said clock signal thereby producing a modulated output signal.

2. The circuit arrangement of claim 1, wherein said safety switching device disconnects said element as a function of said modulated output signal.

3. The circuit arrangement of claim 1, wherein said defined output signal is a digital signal, and said input stage comprises a logic unit adapted to modulate said digital output signal by means of a logic interconnection with said clock signal.

4. The circuit arrangement of claim 3, wherein said logic interconnection is an exclusive-NOR interconnection.

5. The circuit arrangement of claim 3, wherein said logic interconnection is an exclusive-OR interconnection.

6. The circuit arrangement of claim 1, wherein said input stage further comprises a signal processor adapted to separate said clock signal and said modulated output signal from one another in a fail-safe manner.

7. The circuit arrangement of claim 6, wherein said signal processor galvanically isolates said clock signal and said modulated output signal from one another.

8. The circuit arrangement of claim 7, wherein said signal processor comprises an optocoupler for galvanically isolating said clock signal and said modulated output signal from one another.

9. The circuit arrangement of claim 6, wherein said modulated output signal and said clock signal each comprise signal parameters, and said signal processor changes at least one of said signal parameters differently.

10. The circuit arrangement of claim 1, wherein said safety switching device further comprises a housing with externally accessible connecting terminals, and said clock signal is supplied to said input stage from outside the housing via at least one of said connecting terminals.

11. The circuit arrangement of claim 1, wherein said safety switching device further comprises at least two housing modules which can be separated from one another, with said input stage being arranged on its own in one of said separable housing modules.

12. The circuit arrangement of claim 1, wherein said clock signal comprises pulses having a first pulse duration, and said input stage comprises a filter circuit which is adapted to suppress any pulses whose pulse duration is shorter than said first pulse duration.

13. The circuit arrangement of claim 12, wherein said filter circuit comprises a delay time, which is short compared to said period of time during which said defined output signal is at said steady-state signal level.

14. The circuit arrangement of claim 1, wherein said safety switching device further comprises an evaluation unit for evaluating said defined output signal and for disconnecting said element as a function of said defined output signal, wherein said clock signal is controlled by said evaluation unit.

15. The circuit arrangement of claim 1, wherein at least said input stage is designed in a multichannel fashion.

16. In a circuit arrangement for safely disconnecting an element from electrical power, a safety switching device comprising:
at least one input for receiving an input signal reflecting a input switching condition,
a disconnection unit capable of disconnecting said element from said electrical power in a fail-safe manner depending on said input signal,
a clock generator for generating a clock signal, and
an input stage receiving said input signal and said clock signal, wherein said input stage modulates said input signal with said clock signal thereby producing a modulated input signal.

17. The safety switching device of claim 16, wherein said disconnection unit disconnects said element as a function of said modulated input signal.

18. The safety switching device of claim 16, wherein said input stage further comprises a signal processor adapted to separate said clock signal and said modulated input signal from one another in a fail-safe manner.

19. The safety switching device of claim 18, wherein said signal processor galvanically isolates said clock signal and said modulated input signal from one another.

20. The safety switching device of claim 19, wherein said signal processor includes an optocoupler for galvanically isolating said clock signal and said modulated input signal from one another.

21. The safety switching device of claim 19, wherein said modulated input signal and said clock signal each comprise signal parameters, and said signal processor changes at least one of said signal parameters differently for each signal.

22. The safety switching device of claim 16, further comprising a housing with externally accessible connecting terminals, wherein said clock signal is supplied to said input stage from outside of said housing via at least one of said connecting terminals.

23. The safety switching device of claim 16, further comprising at least two housing modules which can be separated from one another, with said input stage being arranged on its own in one of said separable housing modules.

24. The safety switching device of claim 16, wherein said clock signal comprises pulses having a first pulse duration, and said input stage comprises a filter circuit which is adapted to suppress any pulses whose pulse duration is shorter than said first pulse duration.

25. The safety switching device of claim 16, further comprising an evaluation unit for evaluating said input signal and for disconnecting said element as a function of said input signal, wherein said clock signal is controlled by said evaluation unit.
